(19) United States
(12) Patent Application Publication
(10) Pub. No.: US 2013/0251233 A1
(43) Pub. Date: Sep. 26, 2013

(54) METHOD FOR CREATING A REPORT FROM RADIOLOGICAL IMAGES USING ELECTRONIC REPORT TEMPLATES

(71) Applicants: Guoliang Yang, Singapore (SG); Kim Young, Shrewsbury, MA (US); Su Huang, Singapore (SG); John Shim, Shrewsbury, MA (US); Wieslaw Lucjan Nowinski, Singapore (SG)

(72) Inventors: Guoliang Yang, Singapore (SG); Kim Young, Shrewsbury, MA (US); Su Huang, Singapore (SG); John Shim, Shrewsbury, MA (US); Wieslaw Lucjan Nowinski, Singapore (SG)

(21) Appl. No.: 13/989,774

(22) PCT Filed: Nov. 23, 2011
(86) PCT No.: PCT/US11/62144

§ 371 Date: May 24, 2013

(30) Foreign Application Priority Data
Nov. 26, 2010 (SG) 201008848-2

(51) Int. Cl. G06T 7/00

(52) U.S. Cl. CPC G06T 7/0012
USPC 382/132

(57) ABSTRACT

Creating a report from a radiological image using an electronic report template, the radiological image being an image of an anatomic region and the report template initially having empty fields includes displaying the radiological image on a screen of a workstation; providing a structural template, the structural template being a map of a reference region that corresponds to the anatomical region, t structural template identifying a plurality of anatomical landmarks each associated with corresponding landmark data; fitting the structural template with the radiological image such that the anatomical landmarks match corresponding anatomical landmarks of the radiological image; using the fitting to generate pathological data indicative of a pathology in one or more of the anatomical landmark and using the landmark data and pathological data to populate the empty field of the report template to thereby create the report.

### FIELD OF THE INVENTION

The invention relates to a method for creating a report from a radiological image using an electronic report template.

### BACKGROUND OF THE INVENTION

Radiological images are typically reported by a radiologist narrating his observations and thereafter transcribing the narration into a report. Whilst speech recognition technology has contributed to decreasing the turnaround time require to transcribe a narration and thus create a radiological report, the overall reporting method, structure of the report, and means for inputting the text for the report has seen little change. Radiological reports typically are purely text-based and the text of the report is a typed or automatic transcription of a recorded voice narration.

The current reporting method is time consuming since the radiologist has to alternate between a display of a radiological image, and a voice recorder or text input console when interpreting the radiological image. This method also is error prone because mistakes are introduced by typographical errors or dictation errors. Transcription errors also result from a human or automatic transcription.

Systems permitting the generation of structured reports using basic templates also exist. The basic templates rely on the manual input of text to filled in the templates and/or require the user to select options from a complex nested hierarchy. They are thus inefficient because excessive mouse clicks are required and because they rely on the manual input of text.

### SUMMARY OF THE INVENTION

The present invention aims to provide a new and useful method for creating a report from a radiological image using an electronic report template, and a workstation for carrying out the method.

In general terms, the invention proposes a workstation fitting a structural template with a radiological image such that the anatomical landmarks of the structural template match corresponding anatomical landmarks of the radiological image. The fitting is then used to generate pathological data indicative of a pathology in one or more of the anatomical landmarks and a report is then created by populating an initially empty field of a pre-existing electronic report template with the pathological data.

Specifically, a first expression of the invention is a method for creating a report from a radiological image using an electronic report template, the radiological image being an image of an anatomical region and the report template initially having a plurality of empty fields, the method comprising the steps of
displaying the radiological image on a screen of a workstation;
providing a structural template, the structural template being a map of a reference region that corresponds to the anatomical region, the structural template including a plurality of anatomical landmarks each associated with corresponding landmark data;
fitting the structural template with the radiological image such that the anatomical landmarks match corresponding anatomical landmarks of the radiological image;
using the fitting to generate pathological data indicative of a pathology in one or more of the anatomical landmarks;
using the landmark data and pathological data to populate one of the empty fields of the report template; and
using optical character recognition (OCR) to obtain text from the radiological image and/or downloading information from one of a HIS server, a RIS server or a PACS server, to populate other empty fields of the report template to thereby create the report.

Such a method for creating a report allows a user to create a report with ease, since the process of locating the landmarks is integrated with the process of preparing the report. Furthermore, the process may be even easier if the fitting step is automatic (i.e. performed without human interaction, except perhaps for initialization) or semi-automatic (such as an automatic fitting step followed by a refining step using human interaction). Also, the electronic report template standardizes the resulting report and makes the creation of the report easier and less error prone. Turnaround time for reporting the radiological image is also reduced.

Preferably, the pathological data indicative of the pathology is generated by annotating the one or more of the anatomical landmarks. The annotation of anatomical landmarks in this manner is convenient and intuitive. Advantageously, the one or more of the anatomical landmarks are annotated by selecting the pathology from a list, the list being associated with the one or more anatomical landmarks. This allows annotation to be even more convenient and is made less error prone.

Preferably, the landmark data of one or more of the anatomical landmarks includes edge information delimiting an edge of the anatomical landmark. This allows the limits of the landmark to be accurately visualized by the radiologist.

Preferably, the findings empty fields of the report template is populated by adapting the information derived from the landmark data and pathological data according to a natural language grammatical rule. This results in a report which reads more naturally and which is better understood.

Preferably, the method further comprises the step of including into another one of the empty fields a snapshot of the whole or a part of the radiological image, the snapshot containing annotations (e.g. arrows) on the whole or the part of the radiological image. This allows for an easier visualization of the whole or a part of the radiological image, thus reducing the need to cross-reference between the report and the radiological image.

Preferably, the method further comprises the step of including into other empty fields text transcribed from a voice recording. More preferably, the text is transcribed from a voice recording using an automated speech recognition system. By allowing text to be input using automated methods, productivity is increase while typographical errors are reduced.

Preferably, the step of fitting the structural template includes the steps of
positioning the structural template with the radiological image at a relative offset between the structural template and the radiological image; and
iteratively,
computing a similarity score between the structural template and the radiological image; and
adjusting the relative offset to deform or reposition the structural template with the radiological image to maximize the similarity score.

This allows for a more accurate fitting of the structural template with the radiological image.

Preferably, the structural template is provided by training a statistical model from a plurality of reference images of the reference region.

Preferably, the method further comprises at least one of the steps of
removing artifacts from the radiological image;
homogenizing a part of the radiological image; or
enhancing a feature of the radiological image.

Such a method further allows the quality of the radiological image to be improved and allows features present in the image to be better visualized.

Preferably, the method further comprises the step of adjusting a view of the displayed radiological image on the screen. More preferably, the step of adjusting the view of the displayed radiological image includes
zooming the displayed radiological image;
panning the displayed radiological image; and
changing a perspective of the view of the displayed radiological image.

Viewing the image from multiple different views allows for a more accurate interpretation of the image.

Preferably, the method further comprises the step of displaying the created report in an editor user interface for editing by a user. The user is thus allowed to correct or augment the report after it is created.

Advantageously, the method further comprises the steps of measuring at each step of the method the amount of time taken to perform the step, and after the step of populating the other empty fields of the report template, producing a time report showing the amount of time taken to perform each step. By keeping time, bottle necks in the method are identifiable and this allows for process improvement and optimization.

A second expression of the invention is a workstation for creating a report from a radiological image using an electronic report template, the radiological image being an image of an anatomical region and the report template initially having a plurality of empty fields, the workstation comprising
a screen configured to display the radiological image;
a processor having software configured to receive a structural template, the structural template being a map of a reference region that corresponds to the anatomical region, the structural template identifying a plurality of anatomical landmarks each associated with a corresponding landmark data;
wherein the software is further configured to fit the structural template with the radiological image such that the anatomical landmarks match corresponding anatomical landmarks of the radiological image; and
an input device configured to receive inputs for generating using the fitting, pathological data indicative of a pathology in one or more of the anatomical landmarks;
wherein the software is further configured to use the landmark data and the pathological data to populate one of the empty fields of the report template, and
wherein the software is further configured to use optical character recognition (OCR) to obtain text from the radiological image and/or the software is further configured to download information from one of a HIS server, a RIS server or a PACS server, to populate other empty fields of the report template to thereby create the report. Such a workstation allows a user to create a report with ease since anatomical landmarks are automatically located and identified. Also, the electronic report template standardizes the resulting report and makes the creation of the report easier and less error prone. Turnaround time for reporting the radiological image is also reduced.

Certain embodiments of the present invention may have the advantages of:
allowing for the creation of a content-rich report using radiological images;
allowing for the convenient creation of a radiological report simply by using a series of mouse clicks;
allowing for multiple modes of inputting text into the report; and
allowing for better communication of opinions and observations between the radiologist and clinicians.

### BRIEF DESCRIPTION OF THE FIGURES

By way of example only, one or more embodiments will be described with reference to the accompanying drawings, in which:

FIG. 1 is a schematic drawing of a system for creating a report from a radiological image using an electronic report template according to an example embodiment;

FIG. 2 is a drawing showing the electronic report template that is used in the system of FIG. 1;

FIG. 3 is a flow-chart of a method for creating the report using the system of FIG. 1 and the electronic reporting template of FIG. 2;

FIG. 4a is a drawing showing the radiological image of FIG. 1;

FIG. 4b is a drawing showing the radiological image of FIG. 4a displayed in a graphical user interface;

FIG. 4c is a drawing showing an outline of a reference region of a structural template used in the method of FIG. 3;

FIG. 4d is a drawing showing the radiological image of FIG. 4a with an anatomical landmark identified;

FIG. 5 is a drawing showing the radiological image of FIG. 4a with a structure under the mouse cursor identified;

FIG. 6a is a drawing showing an on-screen menu displayed over a part of the radiological image of FIG. 4a;

FIG. 6b is a drawing showing a pop-up menu leading from the on-screen menu of FIG. 6a;

FIG. 6c is a drawing showing a further hierarchical pop-up menu displayed over the radiological image of FIG. 4a;

FIG. 6d is a drawing showing a portion of another radiological image where on-image text is present;

FIG. 7 is a drawing showing another part of the radiological image of FIG. 4a when taking a snapshot;

FIG. 8 is a drawing showing yet another part of the radiological image of FIG. 4a when using an eraser tool;

FIG. 9 is a screenshot of the report of FIG. 1;

FIG. 10 is a screenshot of the report of FIG. 9 when finalizing the report; and

FIG. 11 is a screenshot of a pop-up window reporting the time taken to perform the steps of the method of FIG. 3.

### DETAILED DESCRIPTION OF THE PREFERRED EMBODIMENT

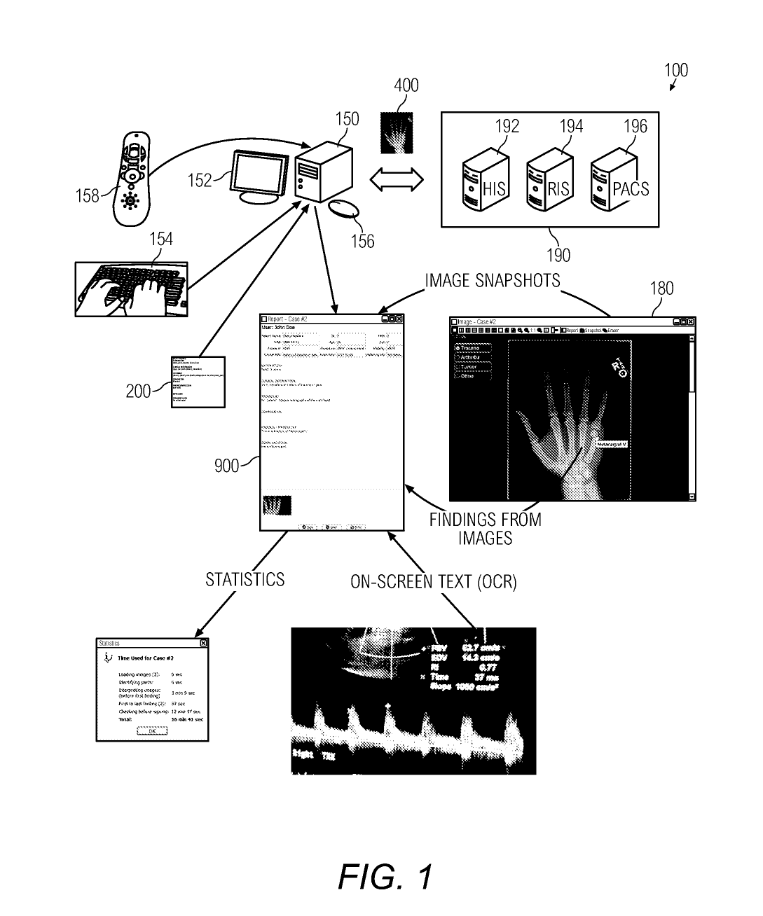

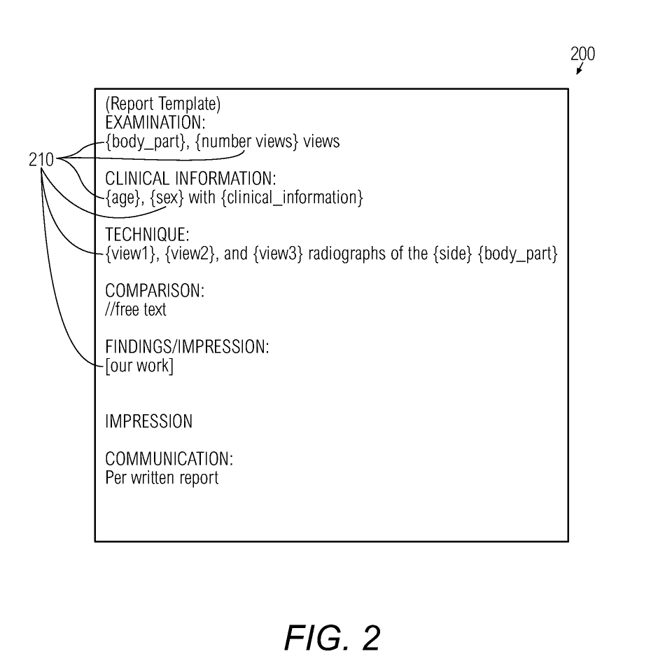

A system for creating a report from a radiological image using an electronic report template is described with the aid of FIGS. 1 and 2. FIG. 1 shows the system 100 according to an example embodiment. FIG. 2 illustrates the electronic report template 200 used to create a report 900.

The system 100 comprises a workstation 150 that is connected to a network 190 via a communications interface (not shown) of the workstation 150. One or more servers are present in the network 190. These servers for example may be a Hospital Information System (HIS) 192, a Radiological Information System (RIS) 194 and/or a Picture Archiving and Communication System (PACS) 196. Each of these servers may be implemented as a separate piece of software running on a separate server, or may be implemented as separate pieces of software running on a common server, or may be implemented as an integrated software suite running on a server. The communications between the workstation 150 and the one or more servers of the network 190, and the communications between the servers of the network 190 all use the DICOM standard.

The workstation 150 further comprises a screen 152 and one or more input devices, e.g. a keyboard 154, a mouse 156 and/or a voice dictation device 158. The workstation 150 is configured to run software using an internal processor (not shown) and the software is capable of displaying one or more graphical user interfaces on the screen 152. Further, the software is configured to retrieve one or more radiological images 400 and to create the report 900 from the one or more radiological images 400. It is envisaged that the one or more radiological images 400 may be retrieved from a local storage (not shown) at the workstation 150, or it may be retrieved from the one or more service provisions systems of the network 190. Specifically, it is envisaged that the one or more images 400 may be retrieved from the PACS 196 of the network 190.

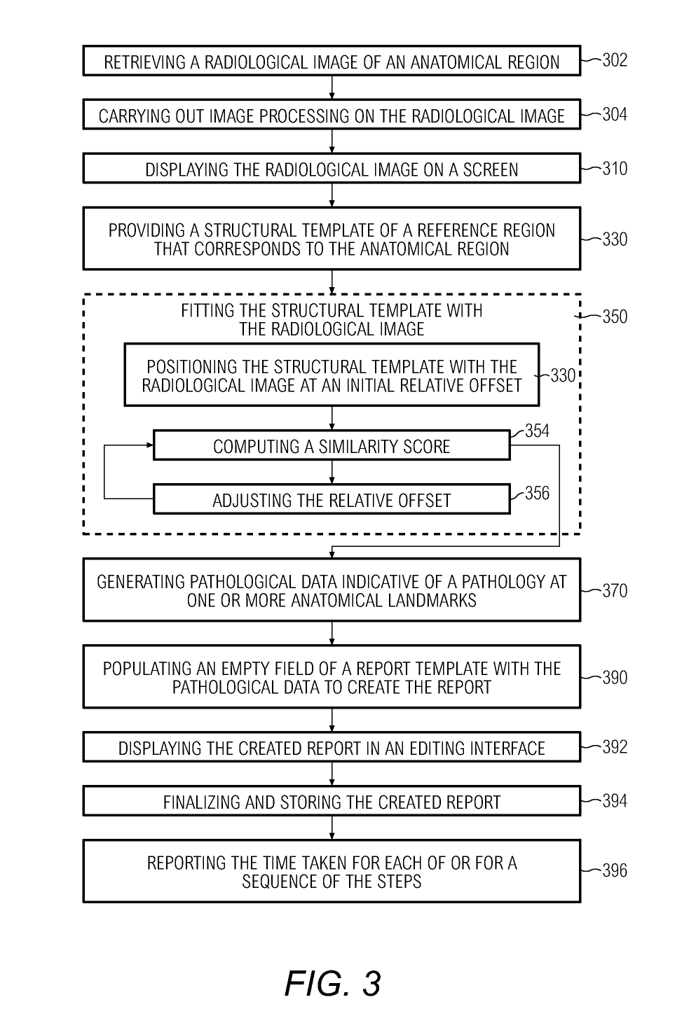

The software is configured to create the report 900 using an electronic report template 200, using the method disclosed later with the aid of FIGS. 3 to 11. This electronic report template 200 may exist as an electronic document, or plurality of electronic documents, and may be retrieved from a template database in the local storage of the workstation 150 or may be retrieved from a template database in the network 190. It is envisaged that the electronic report template 200 contains template data which is for example in a markup language such as XML, or interpreted language containing grammar rules, or plain text containing with empty fields.

The electronic report template 200 includes one or more initially empty fields 210 suitable for receiving data about the image 400 and/or associated patient. These empty fields are suitable for population with textual, image, audio and/or video data. Textual data (reciting, for example, clinical findings about the image 400) may be obtained locally from the keyboard 154 or as a text transcription of a recording made on the voice dictation system 158, or may be obtained from the network 190 as information retrieved from the HIS 192, RIS 194 and/or PACS 196. The text transcription may be obtained using an automated speech recognition system. Image data may be obtained locally as a (e.g. annotated) snapshot 180 of a part of the image 400 or may be obtained from the PACS 196. Audio data may be the recording made on the voice dictation system 158, or may be any audio captured by the workstation 150. Specifically referring to FIG. 2, the empty fields 210 are represented by placeholder names delimited by ellipses.

After creating the report 900 using the electronic report template 200, the software is configured to store the report 900 into a reports database. The report database may exist locally on the workstation, or may exist on the network 190 for example at the HIS 192 or RIS 194.

Optionally, it is envisaged that the software on the workstation 150 may be further configured to allow for a collaborative creation of the report 900 across more than one workstations. In this case, the software runs on each of the more than one workstations and is capable of communicating between the workstations.

Turning to FIG. 3, FIG. 3 shows a method 300 for creating the report 900 of the radiological image 400 using the electronic report template 200.

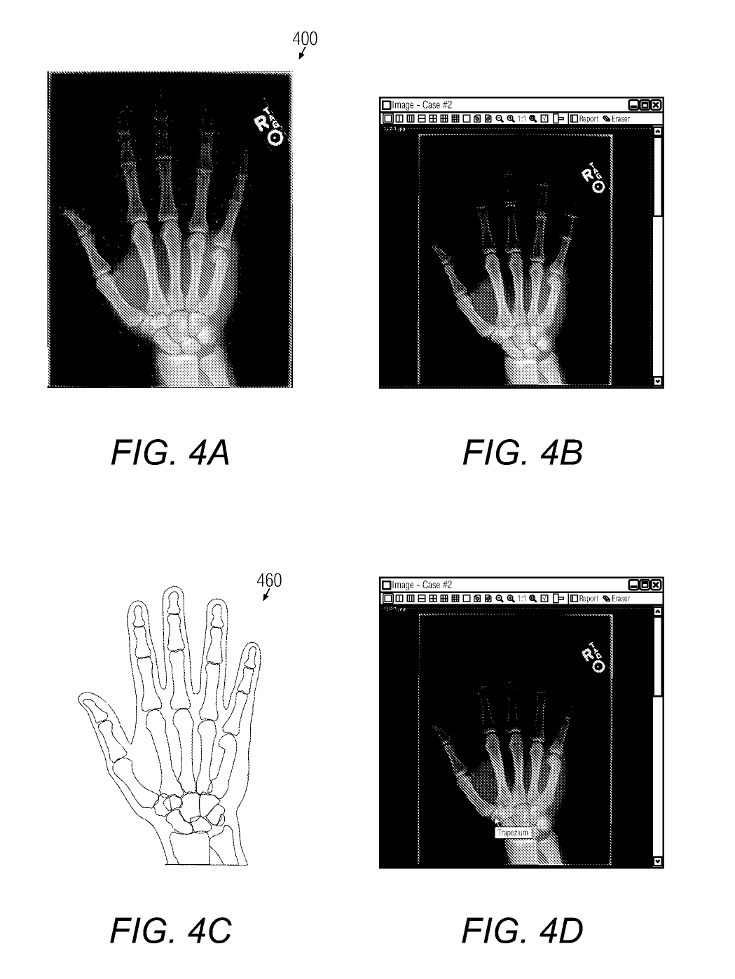

In step 302, the workstation 150 retrieves one or more radiological images. This retrieval is performed according to the DICOM standard in case of DICOM images. FIG. 4a shows an example of such a radiological image 400, the radiological image 400 being of an anatomical region i.e. a right hand. The radiological image 400 may exist locally at the workstation 150 or be retrieved from the network 190. In the latter case, the user of the workstation 150 first logs into the RIS 194 and/or PACS 196 using a user name and password. A list of patients and radiological cases are then displayed to the user on the screen 152. The user selects from the list the patient and/or case which he wishes to view and the associated images are retrieved from the PACS 196.

Optionally, step 304 is performed to carry out image processing on the retrieved radiological image 400. The image processing includes removing artifacts from the radiological image, homogenizing a part of the radiological image or enhancing a feature of the radiological image.

In step 310, the radiological image 400 is displayed on a screen. This is shown in FIG. 4b which shows the radiological image 400 displayed on in a graphical user interface. The radiological image 400 is associated with an anatomical region of the human body (in the case of FIG. 4b, a right hand). The radiological image 400 may for example be a X-ray image or CT, MRI and/or PET tomographic image, and may be comprised of a plurality of such images.

In step 330, the workstation 150 is provided with a structural template 460 of a reference region that corresponds to the anatomical region. The structural template 460 is retrieved based on information residing on the RIS 194 that identifies the radiological image 400. FIG. 4c shows an example of such a reference region (i.e. also of a right hand). The RIS 194 identifies the radiological image 400 to be that of a right hand and thus the structural template 460 that is retrieved is one of a right hand. The structural template 460 may be retrieved locally from within the workstation 150 or may be retrieved from one of the servers (e.g. the PACS 196) of the network 190.

The structural template 460 serves as a map of the reference region and identifies a plurality of anatomical landmarks. Taking the example of the right hand, such anatomical landmarks may be the carpal bones (such as the trapezium) or the metacarpal bones. FIG. 4d shows the radiological image 400 of FIG. 4b with an anatomical landmark i.e. the trapezium identified. Each of the anatomical landmarks is associated with landmark data. The landmark data includes the location of the landmark and pathologies associated with the landmark, as well as text or images for visual cues associated with the landmark.

The structural template 460 is a statistical model which is trained from a plurality of reference images of the reference region. The training of the structural template 460 may be done “off-line” i.e. in a separate session before carrying out the method 300. Different structural templates 460 are trained for reference regions of different parts of the body; body parts such as a hand, a foot, or the chest each have their own structural template 460.

When training a structural template 460 for a reference region, key points are used to delineate contours, edges and boundaries in each of the reference images used. A series of key points in a reference image when connected forms a boundary. These key points are manually marked for each reference image.

Using the set of reference images each with a corresponding set of key points, a statistical shape model is built in order to form the structural template 460. The statistical shape model may be built using for example the active shape model method disclosed in T. F. Cootes and C. J. Taylor and D. H. Cooper and J. Graham (1995). “Active shape models—their training and application”. Computer Vision and Image Understanding (61): 38-59, the contents of which are incorporated herein by reference.

In step 350 (which is made up of sub-steps 352 to 356), the structural template 460 is fitted with the radiological image 400 such that the anatomical landmarks match corresponding anatomical landmarks of the radiological image 400. By fitting the structural template 460 with the radiological image 400, the radiological image 400 is segmented into structures.

In sub-step 352, the structural template 460 is positioned with the radiological image 400 at an initial relative offset between the structural template and the radiological image. The initial relative offset is obtained by identifying features in the radiological image 400 and matching the identified features with corresponding features in the structural template 460.

Sub-steps 354 and 356 then are performed iteratively while moving the structural template 460 (with its model points) around until when an optimum fit is obtained. In sub-step 354, a similarity score is computed between the structural template 460 and the radiological image 400. The structural template 460 includes a plurality of model points which serve as reference points for matching against the radiological image 400. These model points may include one or more of the anatomical landmarks identified in the structural template 460. This similarity score is computed between the model points of the structural template 460 and the corresponding parts of the radiological image 400. An optimum fit is obtained when the similarity score is at its global or local optima.

In sub-step 356, the relative offset between the structural template 460 and the radiological image 400 is adjusted to reposition the structural template 460. Sub-step 354 is then repeated to determine if iterating should end.

In step 370, the user generates pathological data indicative of a pathology in one or more of the anatomical landmarks. This is done by making annotations with the aid of the fitted structural template 460 and the landmark data associated with the anatomical landmarks.

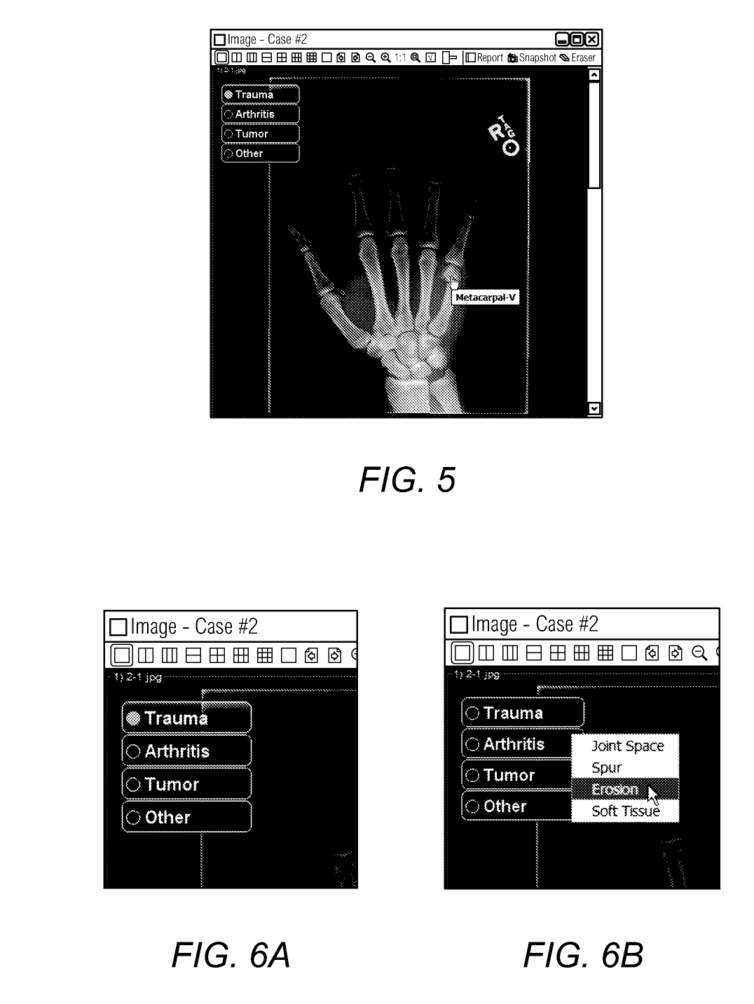

The user uses the mouse 156 to interact with the radiological image 400 and user interface displayed on the screen 152. The user interface provides visual cues to the user by associating the location of the mouse cursor with an anatomical landmark underneath the mouse cursor. Information from the landmark data corresponding to the underlying anatomical landmark can then be displayed in the visual cue. An example of this is shown in FIG. 5 where the name of the structure under the mouse cursor is displayed on the screen. In the example of FIG. 5, the mouse cursor hovers over the fifth metacarpal of the right hand and a pop-up box appears reflecting the name of the structure. Optionally, a visual outline of the structure is also displayed on top of the radiological image 400.

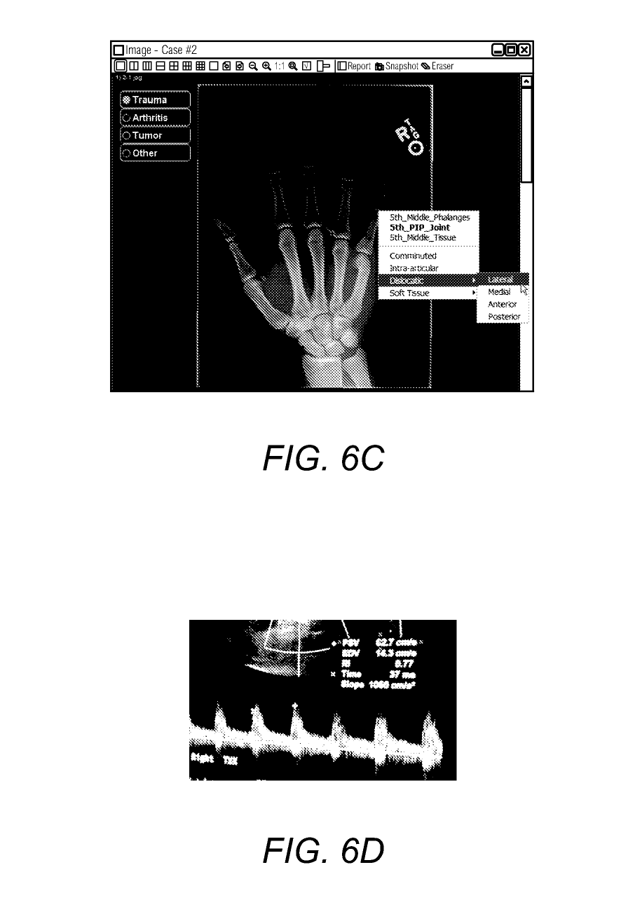

When the user clicks on one of the anatomical landmarks, an on-screen menu is displayed. The on-screen menu displays a list of pathological conditions associated with the anatomical landmark. This list is obtained from the landmark data which is associated with the anatomical landmark. FIG. 6a shows the on-screen menu displayed on a portion of the graphical user interface. Following with the example of the right hand, the specific pathological conditions available in the on-screen menu of FIG. 6a are “trauma”, “arthritis”, “tumor” and “other”. The user is then able to select one or more of the pathological conditions from the list and thus generate pathological data by annotating the anatomical landmark. More specific sub-types of pathological conditions are selectable from a pop-up menu leading from the on-screen menu. Such a pop-up menu is shown in FIG. 6b where further options are available.

Additionally, contextual information about the anatomical landmark may also be selected from the pop-up menu. This is shown in FIG. 6c where the pop-up menu has a menu hierarchy containing a plurality of options for describing the fifth proximal interphalangeal joint i.e. “5th PIP Joint”. The contextual information that is available for selection is obtained from the data associated with the anatomical landmark. Such contextual information may for example include terms of location e.g. “lateral”, “medial”, “anterior” or “posterior”, or words describing progression e.g. “localized”, “intermediate” or “advanced” or morphology e.g. “comminuted”, “simple” or “smooth”. When the user selects a description from the pop-up menu, the anatomical landmark becomes annotated with the description.

When the user left clicks on the radiological image 400, pathological data in the form of a marking of a point, area or region is placed on top of the radiological image 400. In order to mark an area or a region, the user holds the left mouse button as he traces a shape, or as he stretches into place a geometrical shape e.g. a square or a circle. Such markings of an area or a region are used to indicate a non-localized pathological condition, or to select an area of the radiological image 400. It is noted that colour may be used as a differentiator between different markings, and may be used as an indicator of an associated annotation.

Optionally, when the user selects an area of the image 400, the user may be offered the option of performing an Optical Character Recognition (OCR) on the selected area. FIG. 6d shows such a selected area where text is present in. By using OCR technology to recognize and input on-image text, typographic errors are avoided. The recognized text is then used for annotating any one of the anatomical landmarks.

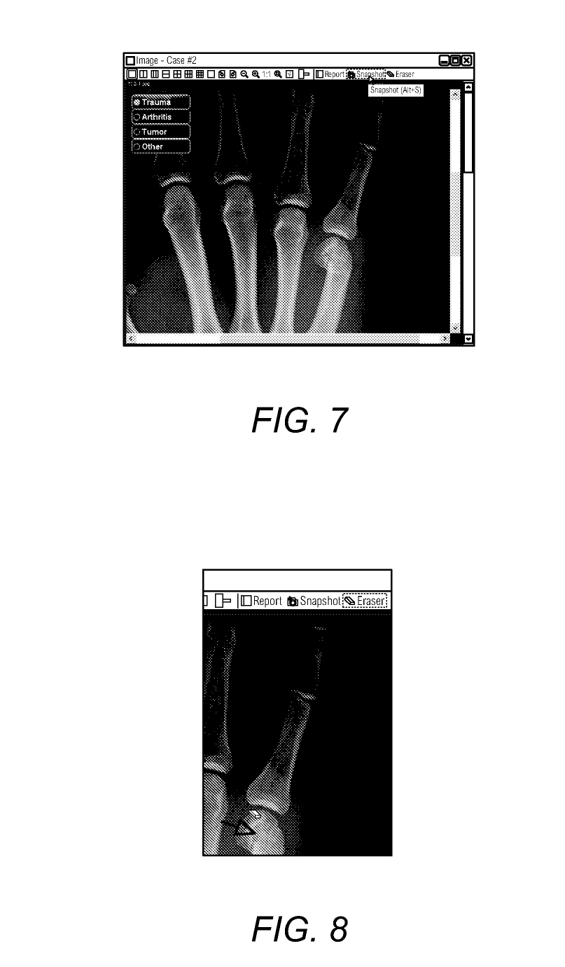

The pathological data generated by the user are not limited to text or markings; they can be multi-media in the form of image, audio or video. This is shown in FIG. 7 which shows the taking of a snapshot of a part of the radiological image 400 using the snapshot tool. By allowing for the pathological data to be multi-media, a better description of a pathological condition is made.

After performing an annotation, should the user change his mind, an eraser tool is provided in the user interface for the user to remove the annotation. Such annotations which are erased are not included in the report which is created in step 390. The eraser tool and associated eraser cursor 810 are shown in FIG. 8.

In the case where multiple anatomical landmarks require annotation, step 370 is repeated for each of the anatomical landmarks in order to generate the pathological data.

In step 390, the empty fields of the electronic report template 200 are populated with the pathological data generated in step 370 and thereby creating a report from the radiological image 400. Step 390 is initiated by the user when he clicks on an option at the workstation.

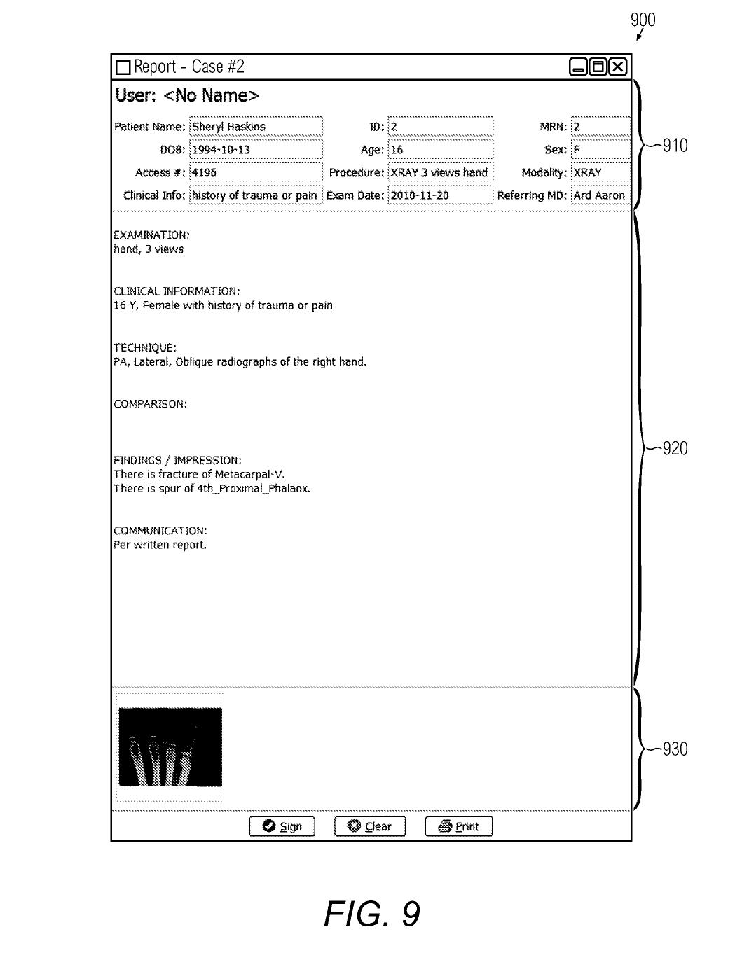

FIG. 9 shows the report 900 that is generated using the report template 200 of FIG. 2. The report 900 comprises a plurality of patient information fields 910, a main report box 920 and a multi-media box 930. The patient information fields 910 are populated by extracting information from databases residing on the HIS 192, RIS 194 and/or PACS 196. Such information may for example be the name, age or blood group of the patient.

The main report box 920 is generated by passing the electronic report template 200 through a parser. The parser interprets the template 200 and recognizes the empty fields 210. These empty fields 210 are populated with the pathological data and/or data obtained from the HIS 192, RIS 194 and/or PACS 196.

The multi-media box 930 contains thumbnails of multi-media data present in the report 900. These thumbnails may be of images, audio or videos which are present in the pathological data.

Referring specifically to the case where the template 200 of FIG. 2 is used, data for the fields “{age}” and “{sex}” are obtained from the HIS 192 while the data for the fields “{body_part}” and “{number_views}” are obtained from the PACS 196. The field “{our work}” is populated with information from the pathological data. Individual pieces of data from within the pathological data are organized using the grammatical rules of a natural human language (e.g. English) to form sentences.

Referring back to FIG. 9, the user in step 370 generated pathological data by annotating in a radiological image of a right hand, the fifth metacarpal with a “fracture” and the fourth proximal phalanx with a “spur”. A snapshot is also made of a part of the image. The pathological data is then organized using the rules to form the sentences:
There is a fracture of Metacarpal V
There is spur of 4th Proximal Phalanx

As is visible in the main report box 920, these sentences are used to replace the field “{our work}” of the template 200 of FIG. 2. A thumbnail of the snapshot is visible in the multi-media box 930.

A report 900 of the radiological image 400 is thus created at the end of step 390. This report may be in draft format i.e. it is suitable for the user to further edit and augment the report in the optional step 392, or it may be ready for storage in which case step 394 is performed.

In step 392, the created report 900 is optionally displayed in an editing interface for editing. The user in this step 392 reviews the report 900 for correctness before finalizing it.

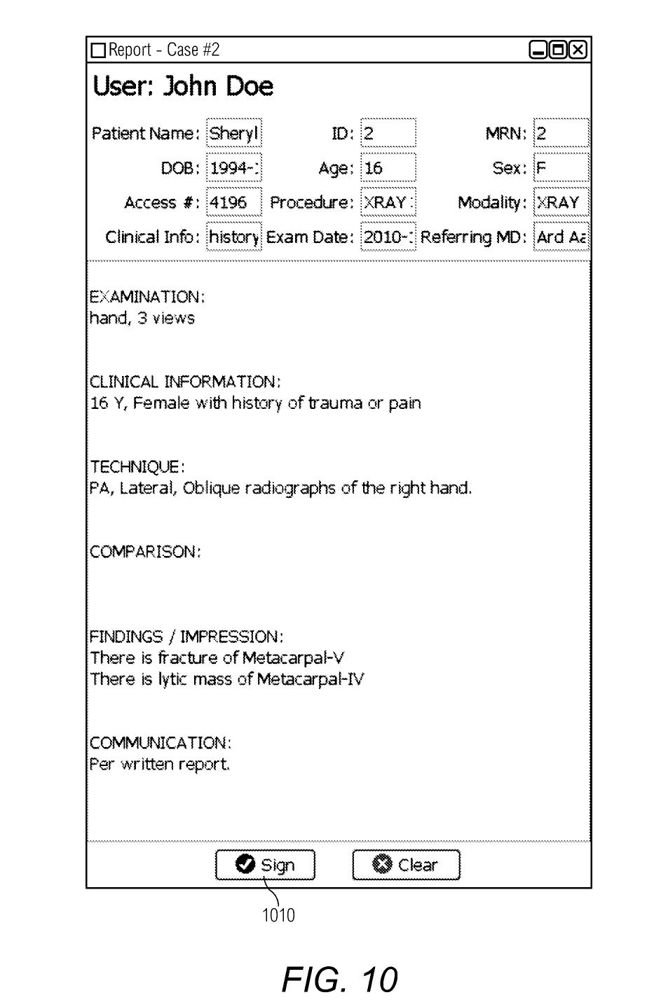

In step 394, the report 900 is finalized and stored, for example at the HIS 192 or RIS 194. As is illustrated in FIG. 10, when finalizing the report 900, a review interface with contents mirroring the report 900 of FIG. 9 is displayed. The user clicks on the “Sign” button 1010 in order to acknowledge finalizing the report 900, and include his digital signature into the report 900.

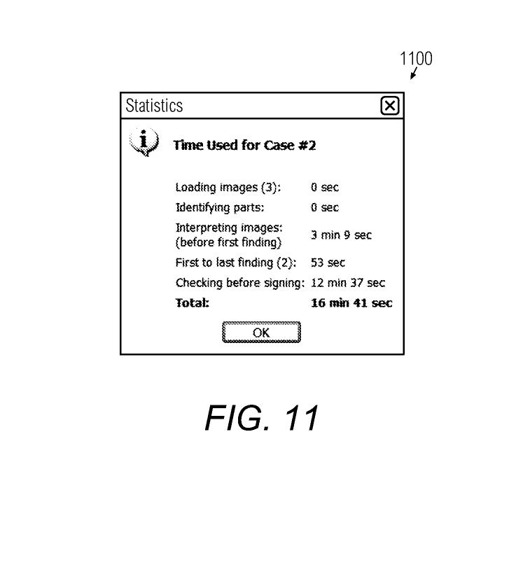

In step 396, the time taken to perform each of the steps or sequence of steps of the method 300 is optionally reported. The amount of time required to perform each step of the method is measured in order to generate the report. The timing report takes the form of a pop-up window 1100 as shown in FIG. 11. Having such a report allows for the identification of process bottle necks and allows for the improvement of productivity.

Optionally, the method 300 may include the step of adjusting a view of the radiological image 400 displayed on the screen anywhere between steps 302 to 390. The views may be adjusted by changing the perspective of the view, e.g. choosing a perspective from a posteroanterior (PA), oblique or lateral view. Additionally, this step may further include the steps of the user zooming in or out of the displayed radiological image, panning the displayed radiological image or window/leveling. The window/leveling of an image refers to the adjustment of the brightness and contrast of the image.

Also, the method 300 may optionally include the step of overlaying a visual template on top of the displayed radiological image 400 anywhere between steps 302 to 390. The visual template provides visual indications as to the anatomical locations on the displayed radiological image 400 and may for example be take the outline of the reference region shown in FIG. 4c. This outline is then displayed on top of the radiological image 400. The visual template may be viewed at different transparency levels so as to allow the user to see detail underlying the template. Further, this step of overlaying the visual template may further include toggling the display of the radiological image 400 on and off. This thus permits the user to view the visual template alone (i.e. without the radiological image 400) or with the visual template overlaid on top of the radiological image 400.

It is noted that while step 370 is described in relation to an on-screen menu or pop-up menu showing a list of pathological conditions, the list however does not have to be exclusively of pathological conditions. The list for example may include general observations (e.g. a flag indicating that a diagnosis cannot be formed, or that the image quality of the feature is poor), or a to-do option (e.g. a flag to notify a clinician to perform a physical inspection of that part of the body). Further, the on-screen menu or pop-up menu may be icon-driven in that their various options are displayed as a series of icons or images.

Optionally, the electronic report template 200 that is used in step 390 may be a template that is selected from a plurality of templates of a template database. The template may be selected automatically based on the image modality and/or the anatomical region of the radiological image.

Additionally, in step 390, more than one electronic report templates 200 may be used to create the report 900. Also, whilst the method 300 is described in relation to creating the report 900 from a radiological image 400, it is envisaged that the report 900 may be created in method 300 using more than one radiological images 400, optionally of more than one anatomical region.

Whilst example embodiments of the invention have been described in detail, many variations are possible within the scope of the invention as will be clear to a skilled reader. For example, the term “anatomical landmark” has been used to refer to an anatomical location in the radiological image and associated structural and electronic report templates and the skilled reader will understand that the “anatomical landmark” may also include an anatomical structure e.g. a part of, or an entire part of, a bone or soft tissue such as an organ. Also, while the invention is described for use with two-dimensional static radiological images, it is understood that the radiological images may instead be radiological videos, or 3D radiological images and models (comprising voxels or vectors), or 3D radiological videos.

1. A method for creating a report from a radiological image using an electronic report template, the radiological image being an image of an anatomical region and the report template initially having a plurality of empty fields, the method comprising the steps of
displaying the radiological image on a screen of a workstation;
providing a structural template, the structural template being a map of a reference region that corresponds to the anatomical region, the structural template including a plurality of anatomical landmarks each associated with corresponding landmark data;
fitting the structural template with the radiological image such that the anatomical landmarks match corresponding anatomical landmarks of the radiological image;
using the fitting to generate pathological data indicative of a pathology in one or more of the anatomical landmarks;
using the landmark data and the pathological data to populate one of the empty fields of the report template; and
using optical character recognition (OCR) to obtain text from the radiological image and/or downloading information from one of a HIS server, a RIS server or a PACS server, to populate other empty fields of the report template to thereby create the report.

2. The method according to claim 1 wherein the pathological data indicative of the pathology is generated by annotating the one or more of the anatomical landmarks.

3. The method according to claim 2 wherein the one or more of the anatomical landmarks are annotated by selecting the pathology from a list, the list being associated with the one or more anatomical landmarks.

4. The method according to claim 1 wherein the landmark data of one of the anatomical landmarks includes edge information delimiting an edge of the anatomical landmark.

5. The method according to claim 1 wherein the one of the empty fields of the report template is populated by adapting the landmark data and pathological data according to a natural language grammatical rule.

6. The method according to claim 1 further comprising the step of including into another one of the empty fields a snapshot of the whole or a part of the radiological image, the snapshot containing annotations on the whole or the part of the radiological image.

7. The method according to claim 1 further comprising the step of including into other empty fields text transcribed from a voice recording.

8. The method according to claim 7 wherein the text is transcribed from a voice recording using an automated speech recognition system.

9. The method according to claim 1 wherein the step of fitting the structural template includes the steps of
positioning the structural template with the radiological image at a relative offset between the structural template and the radiological image; and
iteratively,
computing a similarity score between the structural template and the radiological image; and
adjusting the relative offset to deform or reposition the structural template with the radiological image to maximize the similarity score.

10. The method according to claim 1 wherein the structural template is provided by training a statistical model from a plurality of reference images of the reference region.

11. The method according to claim 1 further comprising at least one of the steps of
removing artifacts from the radiological image;
homogenizing a part of the radiological image; or
enhancing a feature of the radiological image.

12. The method according to claim 1 further comprising the step of
adjusting a view of the displayed radiological image on the screen.

13. The method according to claim 12 wherein the step of adjusting the view of the displayed radiological image includes
zooming the displayed radiological image;
panning the displayed radiological image; and
changing a perspective of the view of the displayed radiological image.

14. The method according to claim 1 further comprising the step of
displaying the created report in an editor user interface for editing by a user.

15. The method according to claim 1 further comprising the steps of
measuring at each step of the method the amount of time taken to perform the step, and
after the step of populating the other empty fields of the report template, producing a time report showing the amount of time taken to perform each step.

16. A workstation for creating a report from a radiological image using an electronic report template, the radiological image being an image of an anatomical region and the report template initially having a plurality of empty fields, the workstation comprising
a screen configured to display the radiological image;
a processor having software configured to receive a structural template, the structural template being a map of a reference region that corresponds to the anatomical region, the structural template identifying a plurality of anatomical landmarks each associated with corresponding landmark data;
wherein the software is further configured to fit the structural template with the radiological image such that the anatomical landmarks match corresponding anatomical landmarks of the radiological image; and
an input device configured to receive inputs for generating using the fitting, pathological data indicative of a pathology in one or more of the anatomical landmarks;
wherein the software is further configured to use the landmark data and pathological data to populate one of the empty fields of the report template, and
wherein the software is further configured to use optical character recognition (OCR) to obtain text from the radiological image and/or the software is further configured to download information from one of a HIS server, a RIS server or a PACS server, to populate other empty fields of the report template to thereby create the report.
